(19) United States
(12) Patent Application Publication
(10) Pub. No.: US 2013/0125139 A1
(43) Pub. Date: May 16, 2013

(54) Logging In A Computer System

(71) Applicant: Waseem A. Roshen, Hilliard, OH (US)

(72) Inventor: Waseem A. Roshen, Hilliard, OH (US)

(73) Assignee: INTERNATIONAL BUSINESS MACHINES CORPORATION, Armonk, NY (US)

(21) Appl. No.: 13/297,632

(22) Filed: Nov. 16, 2011

(51) Int. Cl. G06F 9/44

(52) U.S. Cl. 719/314

(57) ABSTRACT

Logging in a computer system that includes high speed, low latency computer memory and non-volatile computer memory, including: for each transaction of a plurality of transactions in a transaction-based application: beginning execution of the transaction; storing one or more log messages in a message bundle in the high speed, low latency computer memory during execution of the transaction; and upon completion of the transaction, storing the message bundle in a messaging queue; asynchronously with regard to transaction execution: processing, by a logging module, the messaging queue, including identifying one or more log messages stored in message bundles in the messaging queue; and for each identified log message, writing, by the logging module, the log message to the non-volatile computer memory.

### BACKGROUND OF THE INVENTION

1. Field of the Invention

The field of the invention is data processing, or, more specifically, methods, apparatus, and products for logging in a computer system.

2. Description of Related Art

Logging is used for debugging a software application and record keeping for important business transactions. Record keeping and associated auditing capability is usually required, by law or regulations, for software applications related to medical or financial transactions. Many logging frameworks exist. However, most of these frameworks write logs to a file or a database during the execution of the application or computer program. Such files or databases are stored on hard disk drives. Such a write of a log to a file or database is a very slow process because the disk storage has to be accessed at the proper location on the hard disk. This makes these frameworks unsuitable for applications which require extremely high performance. Examples of such high performance include software applications for financial transactions such as online banking transactions. Requirements for response time in such high performance software applications may be for an entire transaction to be less than 1-2 seconds while a single transaction may result in hundreds of log messages. Thus, it is especially inefficient to try to log each of these log messages to the file or database separately during the time the transaction is being processed.

### SUMMARY OF THE INVENTION

Methods, apparatus, and products for transaction logging in a computer system are disclosed in this specification. Such computer systems include high speed, low latency computer memory, such as Random Access Memory (‘RAM’) and non-volatile computer memory, such as hard disk drives. In embodiments of the present invention, logging is carried out by: for each transaction of a plurality of transactions in a transaction-based application: beginning execution of the transaction: storing one or more log messages in a message bundle in the high speed, low latency computer memory during execution of the transaction; and upon completion of the transaction, storing the message bundle in a messaging queue. Logging in accordance with embodiments of the present invention also includes: asynchronously with regard to transaction execution: processing, by a logging module, the messaging queue, including identifying one or more log messages stored in message bundles in the messaging queue; and for each identified log message, writing, by the logging module, the log message to the non-volatile computer memory.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a computer system that supports logging according to embodiments of the present invention.

FIG. 2 sets forth a flow chart illustrating an exemplary method for logging in a computer system according to embodiments of the present invention.

FIG. 3 sets forth a flow chart illustrating a further exemplary method for logging in a computer system according to embodiments of the present invention.

FIG. 4 sets forth a flow chart illustrating a further exemplary method for logging in a computer system according to embodiments of the present invention.

### DETAILED DESCRIPTION OF EXEMPLARY EMBODIMENTS

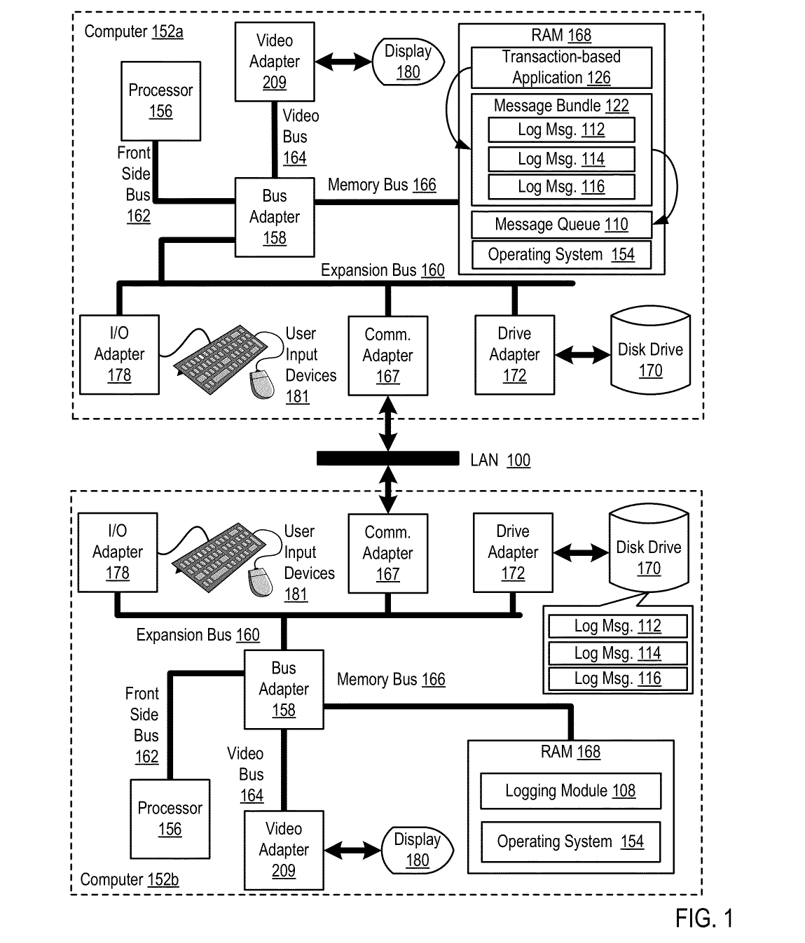

Exemplary methods, apparatus, and products for logging in a computer system in accordance with the present invention are described with reference to the accompanying drawings, beginning with FIG. 1. FIG. 1 sets forth a block diagram of a computer system that supports logging according to embodiments of the present invention. The system of FIG. 1 includes automated computing machinery implementing two computers (152a and 152b). Such computers, when configured to operate together to perform a common task may be described as ‘compute nodes.’Each of the example computers in the system of FIG. 1 includes similar components, designated by the same reference numerals.

The exemplary computer (152a) operates generally for logging according to embodiments of the present invention. The computer (152a) of FIG. 1 includes at least one computer processor (156) or ‘CPU’ as well as random access memory (168) (RAM') which is connected through a high speed memory bus (166) and bus adapter (158) to processor (156) and to other components of the computer (152a). The RAM (168) in the computer (152a) of FIG. 1 is an example of a high speed, low latency computer memory. That is, accesses to the RAM—due to the characteristics of random access memory and the high speed memory bus (166)—are executed quickly relative to other types of memory, such as non-volatile memory implemented as a disk drive (170).

Stored in RAM (168) is a transaction-based application (126), a module of computer program instructions that executes one or more transactions, each of which may generate one or more log messages describing activity carried out during the transaction. The transaction-based application (126) in the example of FIG. 1 supports logging in accordance with embodiments of the present invention by: for each transaction in a transaction-based application: beginning execution of the transaction; storing one or more log messages (112, 114, 116) in a message bundle (122) in the high speed, low latency computer memory (168) during execution of the transaction; and, upon completion of the transaction, storing the message bundle (122) in a messaging queue (110).

A log message as the term is used in this specification is a description of an activity carried out during execution of a transaction. Log messages may include a timestamp indicating a time the log message was generated, a descriptor that indicates a type of activity, an identifier of the log message, data describing the activity carried out, and so on. An example of a log message for a financial transaction, for example, may specify a request to transfer funds from a particular bank account, identified in the log message as a bank number, at a particular financial institution, identified by an Internet Protocol (‘IP’) address, amount of funds to transfer, date to execute the transfer, response to the request, a bank account number to receive the funds, and various other data.

A message bundle is a data structure or object configured to store a number of log messages. At the application level—that is, from the perspective of the transaction-based application (126)—a message bundle may be a global variable implemented as an instance of a class. Message bundles may be structured in a format suitable for sending as a data communications message at any level of a data communications protocol. A message bundle, for example, may be formatted as an application-level message, as a transport layer message, network layer message, link layer message, and so on as will occur to readers of skill in the art. Such a message bundle may include a header including, among other information, an intended recipient of the message bundle.

A messaging queue (110) is a buffer for storing message bundles, from which messages are transmitted to an intended recipient. In the example of FIG. 1, the messaging queue (110) may be processed by an application layer or system layer data communications module in a First-in-First-out manner, where the first message bundle processed is the first message bundle arriving in the queue. Although the messaging queue (110) is depicted in the example of FIG. 1 as being stored in RAM (168), readers of skill in the art will recognize that such a messaging queue may be a queue implemented in memory of the communications adapter (167). Message bundles stored in the messaging queue (110) of FIG. 1 by the transaction-based application (126) are sent to a logging module (108).

In the example of FIG. 1, the logging module (108) is a module of computer program instructions that executes on computer (152b). A logging module (108) useful in computer systems that support logging in accordance with embodiments of the present invention, however, may execute on the same computer as the transaction-based application (126). The logging module, for example, may execute on the same computer upon which the transaction-based application (126) executes, when the computer includes with multiple computer processors or multiple cores that are configured to execute simultaneously.

The logging module (108) in the example of FIG. 1 supports logging in accordance with embodiments of the present invention by processing the messaging queue (110), including identifying one or more log messages (112, 114, 116) stored in message bundles (122) in the messaging queue (110) and, for each identified log message, writing the log message (112, 114, 116) to the non-volatile computer memory. In the example of FIG. 1, the logging module (108) may process the messaging queue (110) and write the log messages (112, 114, 116) asynchronously with regard to transaction execution. That is, the logging module writes the log messages to non-volatile memory independently of the execution of the transaction-based application (126). In this way, execution of the transaction-based application (126) need not be halted during the time consuming process of writing the log messages to the non-volatile memory (170).

Also stored in RAM (168) of both computers (152a, 152b) is an operating system (154). Operating systems useful in a computer system that supports logging according to embodiments of the present invention include UNIX™, Linux™, Microsoft XP™, AIX™, IBM's i5/OS™, and others as will occur to those of skill in the art. The operating system (154) off FIG. 1 is shown in RAM (168), but many components of such software may also be stored in non-volatile memory, such as, for example, on a disk drive (170).

The computers (152a, 152b) of FIG. 1 include a disk drive adapter (172) coupled through expansion bus (160) and bus adapter (158) to a processor (156) and other components of the computer (152a, 152b). The disk drive adapter (172) connects non-volatile data storage to the computer in the form of disk drive (170). Disk drive adapters useful in computers configured for logging according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computers (152a, 152b) of FIG. 1 include one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computers (152a, 152b) of FIG. 1 include a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computers of FIG. 1 include a communications adapter (167) for data communications with other computers and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for logging in a computer system according to embodiments of the present invention include modems for wired dial-up communications, Ethernet (IEEE 802.3) adapters for wired data communications network communications, and 802.11 adapters for wireless data communications network communications.

The arrangement of computer, networks, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

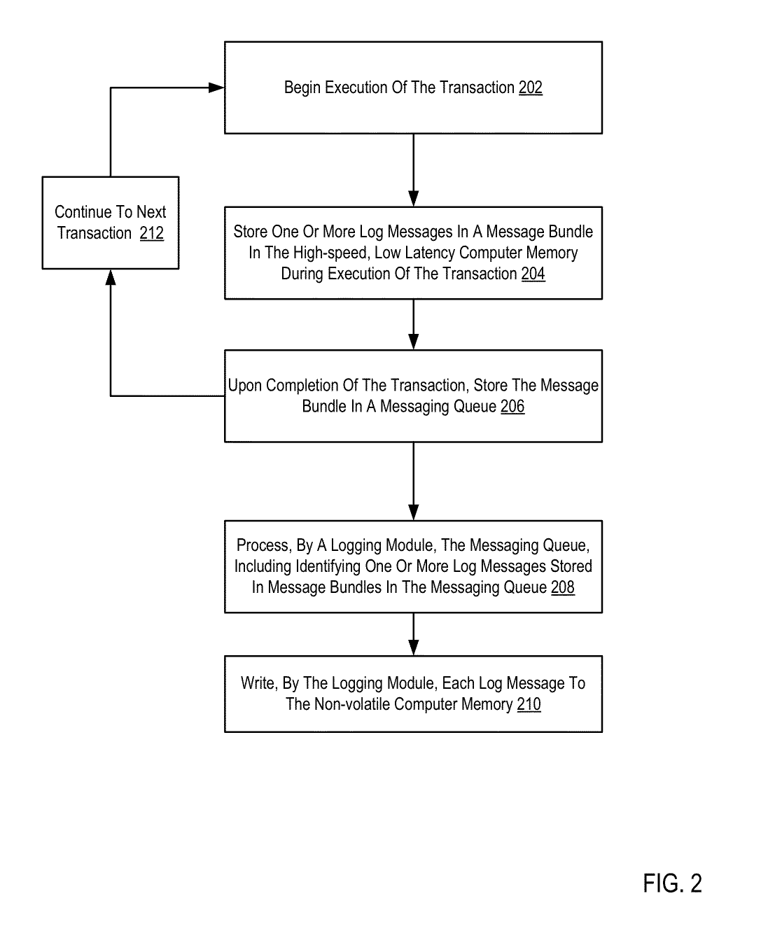

For further explanation, FIG. 2 sets forth a flow chart illustrating an exemplary method for logging in a computer system according to embodiments of the present invention. The computer system includes high speed, low latency computer memory and non-volatile computer memory and the method includes beginning (202) execution of a transaction. During execution of the transaction, the method of FIG. 2 includes storing (204) one or more log messages in a message bundle in the high speed, low latency computer memory. Storing (204) log messages in a message bundle in high speed, low latency computer memory may be carried out in various ways including, for example, by—at the application level—storing values of fields of the log message in an element of an array designated as a message bundle. Below the application level, the value is stored in a memory location in the high speed, low latency computer memory.

Upon completion of the transaction, the method of FIG. 2 continues by storing (206) the message bundle in a messaging queue. In the example of FIG. 2, storing (206) the message bundle in a message queue may be coded into the exit routine of a transaction.

In the method of FIG. 2, beginning (202) a transaction, storing (204) log messages in a message bundle during execution of the transaction, and storing (206) the message bundle in a messaging queue upon completion of the transaction is carried out for each transaction of a plurality of transactions in a transaction-based application. That is, upon completion of one transaction, the method of FIG. 2 continues (212) to a next transaction and begins that transaction.

Asynchronously with regard to transaction execution, the method of FIG. 2 includes processing (208), by a logging module, the messaging queue. Such processing (208) in the method of FIG. 2 includes identifying one or more log messages stored in message bundles in the messaging queue. For each identified log message, the method of FIG. 2 includes writing (210), by the logging module, the log message to the non-volatile computer memory. Writing (210) the log message to non-volatile computer memory may include storing the message in a file or database on a hard disk drive.

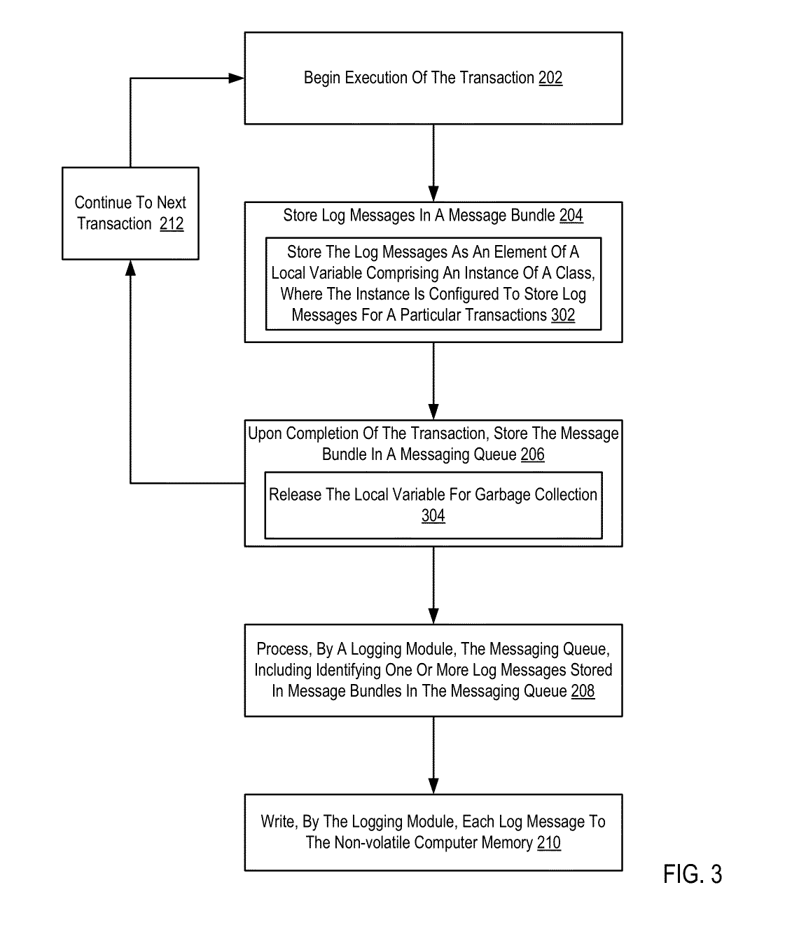

For further explanation, FIG. 3 sets forth a flow chart illustrating a further exemplary method for logging in a computer system according to embodiments of the present invention. The method of FIG. 3 is similar to the method of FIG. 2 in that the method of FIG. 3 also includes: beginning (202) execution of the transaction; storing (204) one or more log messages in a message bundle in the high speed, low latency computer memory during execution of the transaction; and upon completion of the transaction, storing (208) the message bundle in a messaging queue. Asynchronously with regard to transaction execution, the method of FIG. 3, like FIG. 2, also includes processing (208), by a logging module, the messaging queue, and, for each identified log message, writing (210), by the logging module, the log message to the non-volatile computer memory.

The method of FIG. 3 differs from the method of FIG. 2, however, in that in the method of FIG. 3 storing (204) one or more log message in a message bundle further comprises storing (302) the log messages as an element of a local variable implementing an instance of a class. In the example of FIG. 3, the instance of the class (an object) is configured to store log messages for a particular transaction. The instance, for example, may be implemented as a linked list object and each entry in the list may include a log message.

Also in the method of FIG. 3, storing (206) the message bundle in a messaging queue is includes releasing (304) the local variable for garbage collection. That is, the local variable implementing an instance of a class in which log message are stored is a temporary variable, used only during the execution of a single transaction.

Consider, for further explanation, the following example pseudo-code:

LinkedList linkedList = new LinkedList( );
...
...
LinkedList.add (new LogMessage (String transactionId, TimeStamp
currentTime, String message));
...

In the example pseudo-code above, the variable “linkedList” is configured as a local variable implementing an instance of the class configured to temporarily store log messages in RAM. The method call “linkedList.add( . . . )” creates within the local variable, a log message with the following fields:
‘tranactionID’ which identifies the transaction to which the log message is associated;
‘TimeStamp currentTime’ which is a time stamp indicating the time at which the log message is created, specifically, the current time; and
‘message’ which is a string of characters that contains the description of the actual log message.

The example “linkedList.add( . . . )” function call may be called once, for each log message generated during execution of a single transaction.

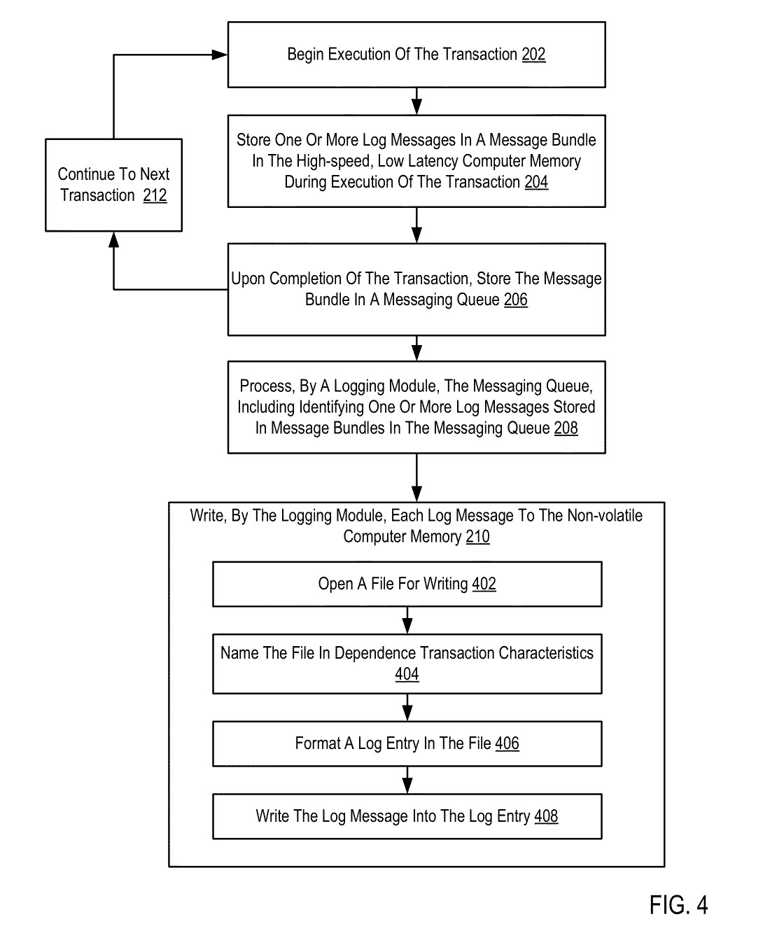

For further explanation, FIG. 4 sets forth a flow chart illustrating a further exemplary method for logging in a computer system according to embodiments of the present invention. The method of FIG. 4 is similar to the method of FIG. 2 in that the method of FIG. 4 also includes: beginning (202) execution of the transaction; storing (204) one or more log messages in a message bundle in the high speed, low latency computer memory during execution of the transaction; and upon completion of the transaction, storing (208) the message bundle in a messaging queue. Asynchronously with regard to transaction execution, the method of FIG. 4, like FIG. 2, also includes processing (208), by a logging module, the messaging queue, and, for each identified log message, writing (210), by the logging module, the log message to the non-volatile computer memory.

The method of FIG. 4 differs from the method of FIG. 2, however, in that in the method of FIG. 4 writing (210), by the logging module, the log message to the non-volatile computer memory further comprises opening (402) a file for writing, naming (404) the file in dependence transaction characteristics, formatting (408) a log entry in the file, and writing (408) the log message into the log entry.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of transaction logging in a computer system, the computer system comprising high speed, low latency computer memory and non-volatile computer memory, the method comprising:
for each transaction of a plurality of transactions in a transaction-based application:
beginning execution of the transaction;
storing one or more log messages in a message bundle in the high speed, low latency computer memory during execution of the transaction; and
upon completion of the transaction, storing the message bundle in a messaging queue;
asynchronously with regard to transaction execution:
processing, by a logging module, the messaging queue, including identifying one or more log messages stored in message bundles in the messaging queue; and
for each identified log message, writing, by the logging module, the log message to the non-volatile computer memory.

2. The method of claim 1 wherein storing one or more log message in a message bundle further comprises storing the log messages as an element of a local variable comprising an instance of a class, where the instance is configured to store log messages for a particular transaction; and
storing the message bundle in a messaging queue further comprises releasing the local variable for garbage collection.

3. The method of claim 1 wherein writing, by the logging module, the log message to the non-volatile computer memory further comprises opening a file for writing, naming the file in dependence transaction characteristics, formatting a log entry in the file, and writing the log message into the log entry.

4. The method of claim 1 wherein computer system comprises a plurality of compute nodes, wherein the transaction-based application executes on a first node and the logging module executes on a second node.

5. The method of claim 1 wherein the high speed, low-latency computer memory further comprises Random Access Memory (‘RAM’).

6. The method of claim 1 wherein the non-volatile computer memory further comprises a hard disk drive (‘HDD’).

7. An apparatus for logging in a computer system, the computer system comprising high speed, low latency computer memory and non-volatile computer memory, the apparatus comprising a computer processor, a computer memory operatively coupled to the computer processor, the computer memory having disposed within it computer program instructions that, when executed, cause the apparatus to carry out the steps of:
for each transaction of a plurality of transactions in a transaction-based application:
beginning execution of the transaction;
storing one or more log messages in a message bundle in the high speed, low latency computer memory during execution of the transaction; and
upon completion of the transaction, storing the message bundle in a messaging queue;
asynchronously with regard to transaction execution:
processing, by a logging module, the messaging queue, including identifying one or more log messages stored in message bundles in the messaging queue; and
for each identified log message, writing, by the logging module, the log message to the non-volatile computer memory.

8. The apparatus of claim 7 wherein storing one or more log message in a message bundle further comprises storing the log messages as an element of a local variable comprising an instance of a class, where the instance is configured to store log messages for a particular transaction; and
storing the message bundle in a messaging queue further comprises releasing the local variable for garbage collection.

9. The apparatus of claim 7 wherein writing, by the logging module, the log message to the non-volatile computer memory further comprises opening a file for writing, naming the file in dependence transaction characteristics, formatting a log entry in the file, and writing the log message into the log entry.

10. The apparatus of claim 7 wherein computer system comprises a plurality of compute nodes, wherein the transaction-based application executes on a first node and the logging module executes on a second node.

11. The apparatus of claim 7 wherein the high speed, low-latency computer memory further comprises Random Access Memory (‘RAM’).

12. The apparatus of claim 7 wherein the non-volatile computer memory further comprises a hard disk drive (‘HDD’).

13. A computer program product for logging in a computer system, the computer system comprising high speed, low latency computer memory and non-volatile computer memory, the computer program product disposed upon a computer readable medium, the computer program product comprising computer program instructions that, when executed, cause a computer to carry out the steps of:
for each transaction of a plurality of transactions in a transaction-based application:
beginning execution of the transaction;
storing one or more log messages in a message bundle in the high speed, low latency computer memory during execution of the transaction; and
upon completion of the transaction, storing the message bundle in a messaging queue;
asynchronously with regard to transaction execution:
processing, by a logging module, the messaging queue, including identifying one or more log messages stored in message bundles in the messaging queue; and
for each identified log message, writing, by the logging module, the log message to the non-volatile computer memory.

14. The computer program product of claim 13 wherein storing one or more log message in a message bundle further comprises storing the log messages as an element of a local variable comprising an instance of a class, where the instance is configured to store log messages for a particular transaction; and
storing the message bundle in a messaging queue further comprises releasing the local variable for garbage collection.

15. The computer program product of claim 13 wherein writing, by the logging module, the log message to the non-volatile computer memory further comprises opening a file for writing, naming the file in dependence transaction characteristics, formatting a log entry in the file, and writing the log message into the log entry.

16. The computer program product of claim 13 wherein computer system comprises a plurality of compute nodes, wherein the transaction-based application executes on a first node and the logging module executes on a second node.

17. The computer program product of claim 13 wherein the high speed, low-latency computer memory further comprises Random Access Memory (‘RAM’).

18. The computer program product of claim 13 wherein the non-volatile computer memory further comprises a hard disk drive (‘HDD’).

19. The computer program product of claim 13 wherein the computer readable medium comprises a storage medium.

20. The computer program product of claim 13 wherein the computer readable medium comprises a signal medium.
